(19) United States
(12) Patent Application Publication
(10) Pub. No.: US 2017/0092107 A1
(43) Pub. Date: Mar. 30, 2017

(54) PROACTIVE FAMILY HYGIENE SYSTEM

(71) Applicant: International Business Machines Corporation, Armonk, NY (US)

(72) Inventors: Romelia H. Flores, Keller, TX (US); Liping Marlow, Coppell, TX (US); Deanna J. Rowe, Wheaton, IL (US)

(21) Appl. No.: 14/867,111

(22) Filed: Sep. 28, 2015

(51) Int. Cl. G08B 21/24; G08B 26/00

(52) U.S. Cl. CPC G08B 21/245; G08B 26/008

(57) ABSTRACT

Embodiments of the present invention provide a method, computer program product, and computer system for monitoring hygiene tasks. The method includes determining the presence of a user and detecting a user profile associated with that active user. A set of tasks assigned to the user profile is displayed. The progress of the set of tasks is monitored using sensors and the status of the progress is displayed. The method may also alert a second user off the status of the progress.

### BACKGROUND OF THE INVENTION

The present invention relates generally to the field of personal hygiene, and more particularly to managing hygienic tasks by using sensors to collect relevant data.

Personal hygiene involves those practices performed by an individual to care for one's bodily health and well-being, through cleanliness. Motivations for personal hygiene practice include reduction of personal illness, healing from personal illness, optimal health and sense of well-being, social acceptance, and prevention of spread of illness to others. What is considered proper personal hygiene can be cultural-specific and may change over time. Practices that are generally considered proper hygiene include bathing regularly, washing hands regularly, especially before handling food, washing scalp hair, keeping hair short or removing hair, wearing clean clothing, brushing one's teeth, and cutting fingernails. Some practices are gender-specific, while other practices are dependent on age. People tend to develop a routine for attending to their personal hygiene needs. Other personal hygienic practices would include covering one's mouth when coughing, disposing of soiled tissues appropriately, making sure toilets are clean, and making sure food handling areas are clean. Some cultures do not kiss or shake hands to reduce transmission of bacteria by contact. Personal grooming extends personal hygiene as it pertains to the maintenance of a good personal and public appearance, which need not necessarily be hygienic. Personal grooming may involve, for example, using deodorants or perfume, shaving, or combing, besides other practices.

### SUMMARY

A method, computer program product, and computer system for monitoring tasks, comprising: receiving, by one or more computer processors, an indication of a first user; detecting, by one or more computer processors, a user profile associated with the first user based on the indication of the first user; displaying, by one or more computer processors, a set of one or more tasks assigned to the user profile; detecting, by one or more computer processors, progress of the set of one or more tasks being performed; displaying, by one or more computer processors, a status for at least a task of the set of one or more tasks based on the detected progress of the set of one or more tasks; and alerting, by one or more computer processors, a second user of the status.

### BRIEF DESCRIPTION OF THE DRAWINGS

FIG. 1 is a functional block diagram illustrating an environment, in accordance with an embodiment of the present invention;

FIG. 2 is a flowchart depicting operational steps for detecting the completion of hygiene tasks, in accordance with an embodiment of the present invention;

FIG. 3 is a flowchart depicting operational steps for managing daily tasks, in accordance with an embodiment of the present invention; and

FIG. 4 is a block diagram of internal and external components of a computer system, in accordance with an embodiment of the present invention.

### DETAILED DESCRIPTION

People typically understand the value and benefit of good hygiene and strive to ensure that the younger and older members of their family are also leveraging good hygiene practices. It is not uncommon today for the parents of a family to have limited bandwidth to monitor the hygiene practices of their family members in the early morning or evening hours. Some parents handle this situation by having a babysitter in the morning to ensure that their children complete their morning tasks before heading to school. Other parents trust their children to remember to brush their teeth, eat their breakfast, take their lunch, and perform other tasks before leaving for school. Embodiments of the present invention recognize that families are in need of the ability to easily manage and ensure that good hygiene is practiced and daily tasks are performed. Embodiments of the present invention provide systems and methods for monitoring hygiene activity and managing a user's daily routine.

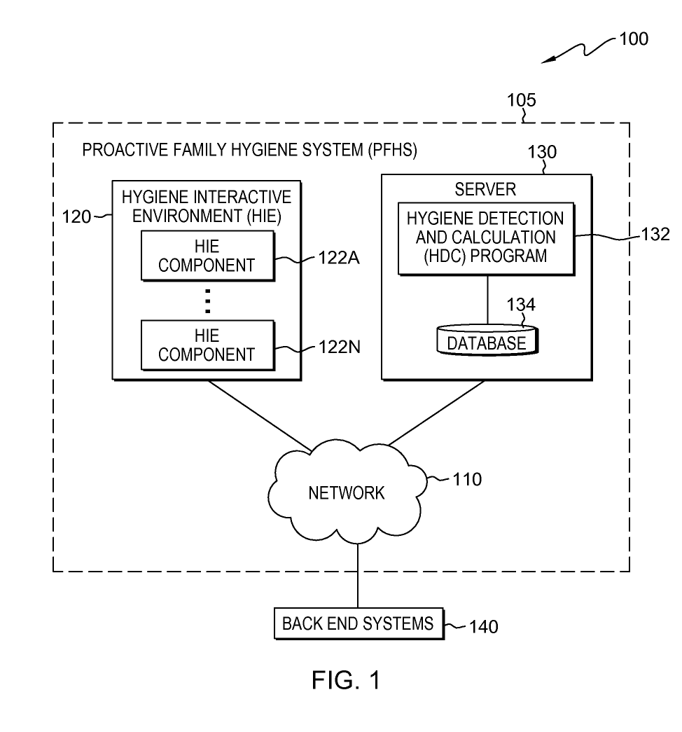

The present invention will now be described in detail with reference to the figures. FIG. 1 is a functional block diagram illustrating a proactive family hygiene processing environment, generally designated 100, in accordance with one embodiment of the present invention. FIG. 1 provides only an illustration of one implementation, and does not imply any limitations with regard to the environments in which different embodiments may be implemented. Many modifications to the depicted environment may be made by those skilled in the art without departing from the scope of the invention as recited by the claims. In an exemplary embodiment, proactive family hygiene system processing environment 100 includes hygiene interactive environment (HIE) 120, server 130, and back end systems 140 interconnected over network 110.

In one embodiment, proactive family hygiene system (PFHS) 105 can be located in either the bathroom or in a hallway, or both to provide different functionalities. In other embodiments, PFHS 105 includes one or more HIE components (e.g., HIE components 122A-122N) located throughout a household. Multiple PFHS 105 throughout the household are synchronized to allow seamless interaction. In some embodiments, each PFHS 105 may have varying functionality, based on the location of the respective PFHS 105. PFHS 105 in the bathroom, for example, is designed for hygiene optimization, while PFHS 105 in the hallway is primarily used to oversee schedules and attire. PFHS 105 may use a mirror or monitor to communicate and display information to the end user. PFHS 105 can be utilized by one or more hygiene users needing recommendations and monitoring as well as one or more guardians wanting to track the hygiene habits of their dependents.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication between HIE 120, server 130, and back end systems 140.

HIE 120 includes HIE components 122A-N that interact with the hygiene users and guardians. HIE components 122A-N combined provide appropriate collection and display of information for our system. In this exemplary embodiment, HIE components 122A-N include user experience, hygiene information system, hygiene devices, and video enablement. It should be appreciated, however, that HIE 120 may use any other suitable component capable of monitoring and encouraging personal hygiene and aiding in management of daily tasks. The user experience component is responsible for the display of information from PFHS 105 via a mirror having display capabilities, mobile device, or browser. Information displayed is based on overall information obtained from PFHS 105. The user experience component is also responsible for the creation of hygiene user and guardian user profiles via a hygiene profile generator. The hygiene information system is the component responsible for the display of historical information to the hygiene user and guardian user. This component provides a dashboard view of information in a summarized form and enables, for example, product recommendations, clothing recommendations, and activity recommendations. The hygiene information system works in collaboration with the user experience component. The hygiene devices component consists of sensors that can be put throughout the house and bathroom to monitor specific interactions and then communicate that information back to PFHS 105. For example, a sensor could be placed on a shower caddy to measure the weight of the items contained in the shower caddy. This sensor could relay information back to PFHS 105, which would determine when the weight falls below a certain level and implies the shampoo and conditioner products are low. This information is stored in database 134 and subsequently is used to notify the end user that more shampoo and/or conditioner must be purchased. Alternatively, PFHS 105 may operate to automatically order replacement shampoo and/or conditioner upon receiving such information. Another sensor device could be placed on a pill bottle to monitor whether or not the pills in the pill bottle were taken as scheduled. This use case would be particularly useful for senior citizens or other individuals who sometimes do not remember to take their medication, or for those who have many types of prescribed medications and have a difficult time keeping track of what they have and have not already taken. Such a sensor could monitor the opening/closing of the bottle, time at which the event occurred, and the weight of the bottle to ensure the pill(s) were taken, etc. In some embodiments, a video enablement component is responsible for surveillance and recognition of users, actions, and products used. The video enablement component can be used to monitor specific activities in front of the mirror or monitor such as, for example, brushing of teeth, mouth rinsing/washing, or detection of particular clothing items (e.g., umbrella, rain coat, sweater, coat, etc.), to subsequently enable PFHS 105 to provide recommendations for activities or clothing required to an individual user or guardian.

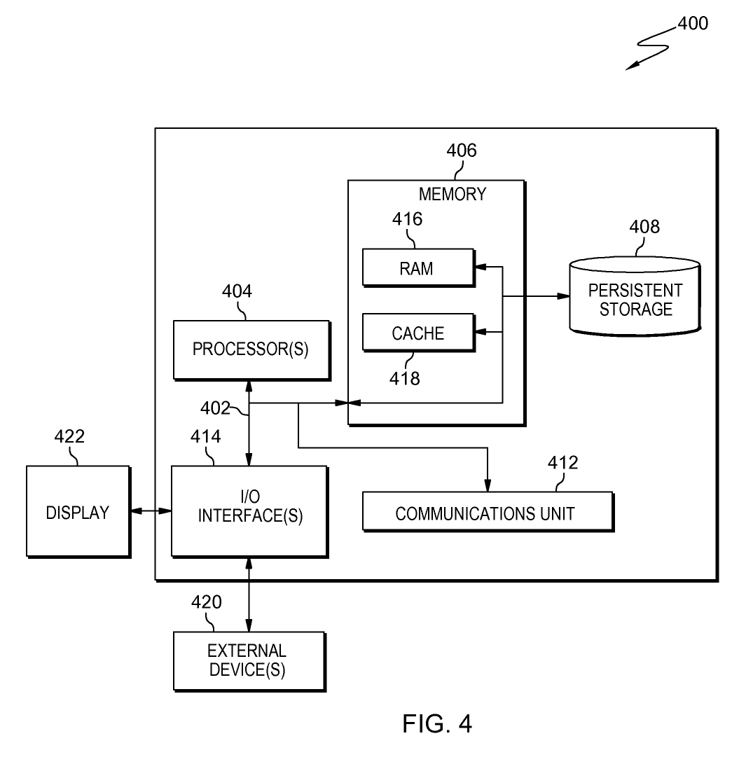

Server 130 includes hygiene detection and calculation (HDC) program 132 and database 134. Server 130 may be a management server, a web server, or any other electronic device or computing system capable of receiving and sending data. Server 130 may be physically located within the home of a user or at a remote location. In other embodiments of the present invention, server 130 can represent a computing system utilizing clustered computers and components to act as a single pool of seamless resources when accessed through a network. In this exemplary embodiment, server 130 is capable of receiving requests for data from HIE 120, via network 110. Server 130 may include internal and external hardware components, as depicted and described in further detail with respect to FIG. 4.

Database 134 is a central storage for a set of health and hygiene data. In this exemplary embodiment, database 134 contains information regarding each individual user, their tasks, hygiene preferences, and schedules as well as any resulting analytics information being produced by the system. Note that one or more databases may be required for video analytics support. Another data source can include external healthcare or hygiene recommendation systems. Profile information can also extend to capture key product information or nearby merchants that are to receive product usage information.

HDC program 132 comprises a set of components leveraged by HIE 120 that handles information being collected from a hygiene user and/or presented to a hygiene user or guardian. All of these components combined provide appropriate analytics, video recognition, and determine appropriate activities. In this exemplary embodiment, HDC program 132 comprises hygiene profile generator, health and hygiene user recognition, health and hygiene activity detector, hygiene alerting, hygiene product recommender, health and wellness advice generator, hygiene travel plan advisor, and outdoor weather advisor. It should be appreciated, however, that HDC program 132 may use any other suitable component capable of monitoring and encouraging personal hygiene and aiding in management of daily tasks. The hygiene profile generator is the component that builds the profiles for both hygiene users and guardian users, including tasks, products, medications, as well as any user preferences (i.e., frequency of notifications, device preferences, etc.). In addition, other family member health history can be stored by this profile generator. The health and hygiene user recognition component operates in conjunction with the health and hygiene activity detector and hygiene profile generator to identify the user that is leveraging any of the components of HIE 120. The health and hygiene activity detector component is a video surveillance system that is leveraged to identify hygiene users and their actions. This component can generate alerts to be delivered to a hygiene user or guardian via HIE 120. The hygiene alerting component is responsible for formatting of alerts to be communicated appropriately so the information can be presented to users through HIE 120. The hygiene product recommender component provides a service interface from PFHS 105 to an external retailer's product campaign offers system. This service shares what products a particular family may be interested in buying (in the near future) to obtain pertinent offers from a retailer. The health and wellness advice generator is the component that leverages individual user profile information (created via the hygiene profile generator) as well as back end systems 140 (i.e., weather alerting, traffic management, and calendar notification systems) to generate advice/recommendations for an individual. Advice and recommendations include, for example, how the user can manage their hygiene and departure information (based on traffic management and calendaring notification information) or clothing recommendations (based on weather alerting information). The hygiene travel plan advisor component leverages travel information collected via back end systems 140 (i.e., the traffic management system) as well as product information collected via HIE 120 in order to determine appropriate travel recommendations for a hygiene user or guardian. The outdoor weather advisor component leverages weather information collected from the back end weather information system as well as video collected via HIE 120 in order to determine appropriate clothing recommendations for a user.

Back end systems 140 comprises a set of components that interact with PFHS 105 to provide enriched services. Back end systems 140 provide information to PFHS 105, which is leveraged and compared with information contained in PFHS 105 to provide appropriate attire and activity advice to the hygiene users. PFHS 105 integrates with product campaign system that retailers or others can make available to obtain proactive product offers based on information (i.e., needed products) determined by PFHS 105. In this exemplary embodiment, back end systems 140 comprises weather information system, traffic management system, calendar mobile notification system, and product campaign offers system. It should be appreciated, however, that back end systems 140 may comprise any other suitable component capable of monitoring and encouraging personal hygiene and aiding in management of daily tasks. The weather information system component provides real-time weather updates to PFHS 105 so that it can advise the hygiene user on appropriate attire for the day. The traffic management system component provides real-time traffic updates to PFHS 105 so that it may advise the hygiene user on how to prepare for the day. For example, PFHS 105 will be able to communicate to the user that there was an accident along the route they typically take to get to work in the morning and should leave earlier than normal, or should take a different route, to make it to work on time. The calendar mobile notification system component works in conjunction with PFHS 105 to notify hygiene users of upcoming events planned for their day. For example, by using the information stored in the calendar system PFHS 105 could alert the user that their first meeting begins at 9:00 AM. The product campaign offers system component collaborates with the hygiene product recommender component to provide marketing offers to the end user. The hygiene product campaign assessor uses the preferred product information from PFHS 105 to find marketing offers and discounts for those brands at a particular retailer.

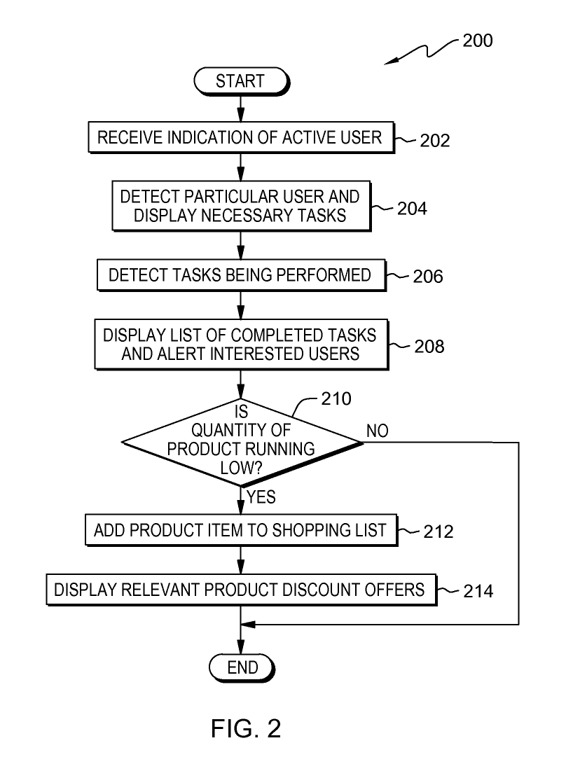

FIG. 2 is a flowchart, 200, depicting operational steps for detecting the completion of basic hygiene tasks, in accordance with an embodiment of the present invention. For illustrative purposes, part of the following discussion is made with respect to HIE component 122A; it being understood that the operational steps of FIG. 2 may be performed by any of HIE components 122A-N capable of performing that function.

In step 202, PFHS 105 receives an indication of an active user. In this exemplary embodiment, PFHS 105 detects that a user is present. For example, the user's voice, presence in front of a camera, or touch activates PFHS 105. PFHS 105 is then able to communicate back through displays, including visual messages and audio. If the user moves from one display to another (i.e., the bathroom to the hallway), the second display will activate in place of the first display. It should be appreciated that the components of each display are identical or similar and share the same back end data.

In step 204, PFHS 105 detects the particular user that is present and displays a checklist of necessary tasks. A set of information can be stored in PFHS 105 for multiple users. As such, PFHS 105 must determine which user is present so as to display the correct checklist of necessary tasks. In this exemplary embodiment, HIE components 122A-N can detect the particular user. For example, PFHS 105 may contain a checklist of necessary morning tasks for each of five family members (e.g., a mother, a father, and three children). In one embodiment, PFHS 105 may detect each user by height. In another embodiment, PFHS 105 may detect each user by voice recognition. In still another embodiment, PFHS 105 may detect each user by facial recognition, other biometric techniques, or by receiving an input of a password or other authentication information. It should be appreciated that any other suitable method for detecting a particular user may be used.

In step 206, PFHS 105 detects a task being performed by a user. In this exemplary embodiment, any of HIE components 122A-N relay information to HDC program 132 which can detect the task being performed. For example, HIE component 122A may be a sensor that detects the rapid motion of a tooth brush (e.g., an accelerometer) and relays this information to HDC program 132 which then determines that the user is brushing his/her teeth. In another example, HIE component 122A might be a sensor that detects the movement of a comb and relays this information to HDC program 132 which determines that the user is combing his hair.

In step 208, PFHS 105 displays a list of completed (or partially completed) tasks and alerts interested users. In this exemplary embodiment, PFHS 105 displays progress toward the set task list for the user. Based on what the user accomplishes, PFHS 105 will check off the items. For example, if the set task is to brush teeth fourteen (14) times per week, PFHS 105 will display the progress the user has made toward that task. Also in this embodiment, PFHS 105 will send an alert to others (e.g., a parent, guardian, etc.) interested in tracking the progress of the user. For example, PFHS 105 may send an alert to a parent once a child has finished brushing his teeth. In another example, PFHS 105 may send an alert to a parent if the child leaves the bathroom, prior to completing assigned hygiene tasks, and does not return for a designated amount of time.

In step 210, PFHS 105 determines whether a quantity of a product associated with the performed task is running low. In this exemplary embodiment, any of HIE components 122A-N calculate the quantity of products being utilized and detect if products are below a predefined threshold and need to be replaced. For example, HIE component 122A may be a sensor that detects the weight of shampoo, indicating how much shampoo remains. Other products include, for example, toothpaste, floss, conditioner, soap, mouthwash, vitamins, and prescription drugs. In an alternate embodiment, PFHS 105 may utilize a camera and use optical character recognition or other techniques to identify hygiene products. Further, such techniques may assist PFHS 105 in determining whether a quantity of a product associated with the performed task is running low. For example, if the product is in a clear (or semi-clear) bottle, images may be analyzed to detect that the contents of the bottle are running low.

If, in step 210, PFHS 105 determines that the quantity of a product is below the predetermined threshold, then in step 212 the product item is added to a shopping list. In this exemplary embodiment, PFHS 105 adds an item to a shopping list when HIE components 122A-N determine that that quantity of a product is below the predetermined threshold. In an alternate embodiment, the item is automatically purchased from an online retailer and shipped to the household.

In step 214, in an example embodiment, PFHS 105 displays relevant product discount offers. In this exemplary embodiment, PFHS 105 retrieves discount offers from back end systems 140 for each item on the shopping list. For example, back end systems 140 may contain a product campaign offers system component to provide marketing offers to the user. Further, PFHS 105 may present discount offers based on other products used by users of PFHS 105 if, for example, such products are on sale.

Accordingly, by performing the operational steps of FIG. 2, the completion of hygiene tasks can be detected and a user can manage a daily routine.

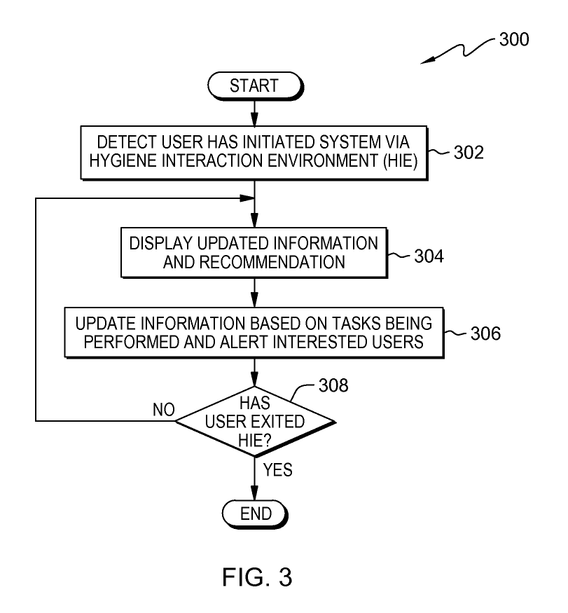

FIG. 3 is a flowchart, 300, depicting operational steps for managing daily tasks, in accordance with an embodiment of the present invention.

In step 302, PFHS 105 detects that a user has initiated the system via HIE 120. In this exemplary embodiment, HIE 120 identifies the user using HIE components 122A-N. This step is similar to steps 202 and 204 above. For example, once a user stands in front of the mirror to begin their morning tasks, the mirror identifies him/her through HIE 120. PFHS 105 will provide the user with their latest hygiene information. The user can view recommendations being made by the system such as brush teeth, brush hair, take daily medication, etc. During initial set up of PFHS 105, user profiles can be created, tasks can be assigned, product information can be logged, and interested users (e.g., parents) can manage other users' activities as well as their own. For example, using the hygiene profile generator component, an interested user can assign tasks to a user as well as products to be monitored, and PFHS 105 will record this information to the database 134.

In step 304, PFHS 105 displays updated information and recommendations. In this exemplary embodiment, PFHS 105 has the ability to display an overview of the day including the important activities from the user's calendar. PFHS 105 may also provide an optimized driving route to key locations based on current traffic and weather conditions. By correlating calendar events with key locations and traffic flows, PFHS 105 can alert the user if they are likely to be on time for their first appointment. PFHS 105 can also provide advice on clothing based on the weather and tasks on the calendar. For example, if the user has an intramural soccer game at night but is currently dressed in business attire, PFHS 105 can remind the user that their schedule requires wearing athletic clothing.

In step 306, PFHS 105 updates information based on tasks being performed and alerts interested users. In this exemplary embodiment, PFHS 105 will check off tasks from the user's task list, displaying unfinished tasks on the display to remind them of tasks that still needs to be completed. If the user moves away from PFHS 105 and tasks are left uncompleted, then an alert can be sent to interested users.

In step 308, PFHS 105 determines whether the user has exited HIE 120. If the user has not exited HIE 120, then PFHS 105 proceeds back to step 304 and displays updated information and recommendations.

Accordingly, by performing the operational steps of FIG. 3, the completion of hygiene tasks can be detected and a user can manage a daily routine.

FIG. 4 is a block diagram of internal and external components of computing device 400, which is representative of the computing devices of FIG. 1, in accordance with an embodiment of the present invention. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 400 includes communications fabric 402, which provides for communications between one or more processing units 404, memory 406, persistent storage 408, communications unit 412, and one or more input/output (I/O) interfaces 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 416 and cache memory 418. In general, memory 406 can include any suitable volatile or non-volatile computer readable storage media. Software is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computerreadable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computerreadable storage medium that is also part of persistent storage 408.

Communications unit 412 provides for communications with other computer systems or devices via a network. In this exemplary embodiment, communications unit 412 includes network adapters or interfaces such as a TCP/IP adapter cards, wireless Wi-Fi interface cards, or 3G or 4G wireless interface cards or other wired or wireless communications links. The network can comprise, for example, copper wires, optical fibers, wireless transmission, routers, firewalls, switches, gateway computers and/or edge servers. Software and data used to practice embodiments of the present invention can be downloaded to computing device 400 through communications unit 412 (i.e., via the Internet, a local area network, or other wide area network). From communications unit 412, the software and data can be loaded onto persistent storage 408.

One or more I/O interfaces 414 allow for input and output of data with other devices that may be connected to computing device 400. For example, I/O interface 414 can provide a connection to one or more external devices 420 such as a keyboard, computer mouse, touch screen, virtual keyboard, touch pad, pointing device, or other human interface devices. External devices 420 can also include portable computerreadable storage media such as, for example, thumb drives, portable optical or magnetic disks, and memory cards. I/O interface 414 also connects to display 422.

Display 422 provides a mechanism to display data to a user and can be, for example, a computer monitor. Display 422 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for monitoring tasks, the method comprising:
receiving, by one or more computer processors, an indication of a first user;
detecting, by one or more computer processors, a user profile associated with the first user based on the indication of the first user;
displaying, by one or more computer processors, a set of one or more tasks assigned to the user profile;
detecting, by one or more computer processors, progress of the set of one or more tasks being performed;
displaying, by one or more computer processors, a status for at least a task of the set of one or more tasks based on the detected progress of the set of one or more tasks; and
alerting, by one or more computer processors, a second user of the status.

2. The method of claim 1, wherein the set of one or more tasks comprises a set of one or more hygiene tasks.

3. The method of claim 1, wherein the indication of the first user includes, at least, biometric information of the first user received from one or more sensors.

4. The method of claim 1, wherein detecting the progress of the set of one or more tasks being performed comprises:
receiving, by one or more computer processors, information from one or more sensors; and
determining, by one or more computer processors, that a task of the set of one or more tasks is being performed by the first user based on, at least the received information.

5. The method of claim 1, further comprising:
receiving, by one or more computer processors, information from one or more back end systems; and
providing, by one or more computer processors, recommendations to said first user based on the received information.

6. The method of claim 1, wherein the second user is capable of monitoring the progress of the set of one or more tasks being performed by the first user.

7. The method of claim 1, further comprising:
determining, by one or more computer processors, that a quantity of a product is below a predetermined threshold;
adding, by one or more computer processors, the product to an item list; and
displaying, by one or more computer processors, one or more discount offers for the product.

8. A computer program product comprising:
a computer readable storage medium and program instructions stored on the computer readable storage medium, the program instructions comprising:
program instructions to receive an indication of a first user;
program instructions to detect a user profile associated with the first user based on the indication of the first user;
program instructions to display a set of one or more tasks assigned to the user profile;
program instructions to detect progress of the set of one or more tasks being performed;
program instructions to display a status for at least a task of the set of one or more tasks based on the detected progress of the set of one or more tasks; and
program instructions to alert a second user of the status.

9. The computer program product of claim 8, wherein the set of one or more tasks comprises a set of one or more hygiene tasks.

10. The computer program product of claim 8, wherein the indication of the first user includes, at least, biometric information of the first user received from one or more sensors.

11. The computer program product of claim 8, wherein the program instructions to detect the progress of the set of one or more tasks being performed comprise:
program instructions to receive information from one or more sensors; and
program instructions to determine that a task of the set of one or more tasks being performed by the first user based on, at least the received information.

12. The computer program product of claim 8, further comprising:
program instructions to receive information from one or more back end systems; and
program instructions to provide recommendations to said first user based on the received information.

13. The computer program product of claim 8, wherein the second user is capable of monitoring the progress of the set of one or more tasks being performed by the first user.

14. The computer program product of claim 8, further comprising:
program instructions to determine that a quantity of a product is below a predetermined threshold;
program instructions to add the product to an item list; and
program instructions to display one or more discount offers for the product.

15. A computer system comprising:
one or more computer processors;
one or more computer readable storage media;
program instructions stored on the computer readable storage media for execution by at least one of the one or more computer processors, the program instructions comprising:
program instructions to receive an indication of a first user;
program instructions to detect a user profile associated with the first user based on the indication of the first user;
program instructions to display a set of one or more tasks assigned to the user profile;
program instructions to detect progress of the set of one or more tasks being performed;
program instructions to display a status for at least a task of the set of one or more tasks based on the detected progress of the set of one or more tasks; and
program instructions to alert a second user of the status.

16. The computer system of claim 15, wherein the set of one or more tasks comprises a set of one or more hygiene tasks.

17. The computer system of claim 15, wherein the indication of the first user includes, at least, biometric information of the first user received from one or more sensors.

18. The computer system of claim 15, wherein the program instructions to detect the progress of the set of one or more tasks being performed comprise:
program instructions to receive information from one or more sensors; and
program instructions to determine that a task of the set of one or more tasks being performed by the first user based on, at least the received information.

19. The computer system of claim 15, wherein the second user is capable of monitoring the progress of the set of one or more tasks being performed by the first user.

20. The computer system of claim 15, further comprising:
program instructions to determine that a quantity of a product is below a predetermined threshold;
program instructions to add the product to an item list; and
program instructions to display one or more discount offers for the product.
